(19) United States
(12) Patent Application Publication
(10) Pub. No.: US 2012/0248719 A1
(43) Pub. Date: Oct. 4, 2012

(54) Mobile Cart Base with Traction Wheel

(75) Inventors: Alfred P. Rossini, Southborough, MA (US); Jeffrey M. Silverman, Stoughton, MA (US); Thomas Bagley, Upton, MA (US)

(73) Assignee: Jaco, Inc., Franklin, MA (US)

(21) Appl. No.: 13/439,490

(22) Filed: Apr. 4, 2012

Related U.S. Application Data
(63) Continuation-in-part of application No. 13/035,481, filed on Feb. 25, 2011.
Application No. 13/035,481 is a continuation-in-part of application No. 12/418,338, filed on Apr. 3, 2009, now abandoned.
(60) Provisional application No. 61/308,965, filed on Feb. 28, 2010.
(60) Provisional application No. 61/074,170, filed on Jun. 20, 2008.

(51) Int. Cl. B62B 3/00

(52) U.S. Cl. 280/29

(57) ABSTRACT

A multi-wheeled base for a mobile cart includes one or more swiveling, optionally locking, caster wheels and one or more non-swiveling traction wheels to improve the maneuverability of the cart by making it easier to steer and stop. The traction wheels may be manually-engaged traction wheels, which may be operated by a cam and lever. The traction wheels may also be automatically-engaged traction wheels operated by a motor and a threaded shaft, and activated by a motion-sensitive sensor or by an on/off electrical switch or button. The traction wheels are preferably in contact with the floor when the mobile cart is moving, and raised above the surface of the floor when the cart is stationary.

### CROSS-REFERENCE TO RELATED APPLICATION

This patent application is a continuation-in-part of U.S. patent application Ser. No. 13/035,481, entitled, “MOBILE CART BASE WITH TRACTION WHEEL,” filed on Feb. 25, 2011 which claims priority to U.S. Provisional Patent Application Ser. No. 61/308,965, entitled “MOBILE CART BASE WITH TRACTION WHEEL,” filed on Feb. 28, 2010 and which is a continuation-in-part and claims priority to U.S. patent application Ser. No. 12/418,338, entitled “MOBILE CART,” filed on Apr. 3, 2009, which itself claims priority to U.S. Provisional Patent Application Ser. No. 61/074,170, entitled “BEDSIDE MEDICATION DELIVERY CART,” filed on Jun. 20, 2008, the contents and teachings of each of which are hereby incorporated by reference in their entirety.

### BACKGROUND

Mobile carts are employed in many industries, and may be used to carry a computer, monitor, display, or other electronic equipment; to provide a work surface, such as for a computer keyboard and mouse; and/or to provide portable storage, such as a tray or compartment. The overall weight of some mobile carts, particularly those equipped with electronic equipment and power supplies, may be an ergonomic issue. With an average weight exceeding 100 pounds, pushing a mobile cart can be tiring and cumbersome, especially for smaller users.

In the past, mobile carts have been equipped with four swivel casters or wheels, which permit the user to maneuver the cart around corners, or push it out of the way if necessary, but makes the cart difficult to steer. In particular, the momentum of the cart may be a problem if the cart is moved quickly, as the cart may become difficult to stop or turn. In addition, the carts are difficult to push in a straight line, as the four swivel casters may cause the cart to move slightly from side to side as it pushed, especially if the floors are uneven.

The maneuverability of a mobile cart can be improved by making two of the four casters ridged or non-swiveling. In this configuration, the mobile cart operates much like a shopping cart, and the user steers the cart by controlling the front end. This is not ideal, however, because it is still difficult to turn tight corners, and nearly impossible to pivot in place.

There is a need in the art, then, for a mobile cart that is easy to maneuver; a cart that can turn effortlessly and quickly, without a concern that the momentum of the cart will lead the cart astray. In addition, there is a need for a mobile cart that will move in a straight line when pushed, and will self-adjust so that the wheels stay in contact with the floor, either automatically, in response to the movement of the cart, or manually.

### SUMMARY

The invention provides a multi-wheeled base for a mobile cart. The base may include one or more swiveling, optionally locking, caster wheels and one or more non-swiveling traction wheels to improve the maneuverability of the cart by making it easier to steer and stop. The traction wheels may be manually-engaged traction wheels, which in one non-limiting example may be operated by a cam and lever. The traction wheels may also be automatically-engaged traction wheels operated by a motor and a threaded shaft, activated by a motion-sensitive sensor or by an on/off electrical switch or button.

The multi-wheeled base may comprise a base frame that is generally rectangular, and may include four protruding legs, one leg extending from and proximate each corner of the base frame. One swiveling caster wheel may be mounted to each of the protruding legs. If the base frame does not include the protruding legs, the swiveling caster wheels may be mounted to the base frame at the corners of the base frame.

The base frame is preferably configured to accommodate one or more optional battery cell housings and battery cells, in which case an electrical interconnect assembly is used to connect the battery cells and provide electrical connections for the mobile cart, including the electrical connections needed to power the automatically-engaged traction wheel.

One non-limiting embodiment of the manually-engaged traction wheel includes a traction wheel housing and a cam and lever wheel-positioning assembly. The traction wheel housing includes a wheel assembly sandwiched between two assembly plates, such that the wheel assembly may move up and down a short distance relative to the assembly plates. The up and down movement of the wheel assembly is controlled by the cam and lever assembly, and is guided and limited by elongated slots defined in the assembly plates. When the lever is in a first position, the cam and lever assembly is engaged, the wheel assembly is lowered, and the wheel of the wheel assembly touches the floor or ground. When the lever is moved up or down ninety-degrees from the first position, the cam and lever assembly is disengaged, the wheel assembly is raised, and the wheel is lifted off the floor or ground.

In a non-limiting embodiment, the automatically-engaged traction wheel includes a traction wheel housing and a motor and threaded shaft wheel-positioning assembly. The traction wheel housing includes a wheel assembly sandwiched between two assembly plates, such that the wheel assembly may move up and down a short distance relative to the assembly plates. The up and down movement of the wheel assembly is controlled by the motor and shaft assembly, and is guided and limited by elongated slots defined in the assembly plates. A Hall effect sensor is used to detect an “on/off” signal from a magnet embedded in the rotating wheel. As long as the Hall effect sensor detects the “on/off” signal from the magnet, the motor and the threaded shaft turn such that the wheel assembly is lowered, and the wheel touches the floor or the ground. When the Hall effect sensor stops receiving the “on/off” signal from the magnet, because the wheel is no longer rotating, the motor and the threaded shaft turn such that the wheel assembly is lifted, and the wheel is lifted off the floor or ground.

In an embodiment, mobile cart base comprises a base frame having a generally rectangular shape and a front frame member, a rear frame member, two opposing side members, and a center frame member coupled to the front frame member and the rear frame member, where the center frame member is generally parallel to the opposing side members and generally perpendicular to the front frame member and the rear frame member; four swiveling wheels mounted to the base frame proximate each of the four corners of the base frame; and a non-swiveling traction wheel mounted to the center frame member, where the traction wheel comprises a cam and lever assembly that is adapted to raise and lower the traction wheel relative to the base frame.

In another embodiment, a mobile cart base comprises a base frame having a generally rectangular shape and a front frame member, a rear frame member, two opposing side members, and a center frame member coupled to the front frame member and the rear frame member, where the center frame member is generally parallel to the opposing side members and generally perpendicular to the front frame member and the rear frame member; four swiveling wheels mounted to the base frame proximate each of the four corners of the base frame and a non-swiveling traction wheel mounted to the center frame member, where the traction wheel comprises a motor and threaded spindle assembly that is adapted to raise and lower the traction wheel relative to the base frame.

In one arrangement, base for a cart has a frame, a set of swiveling wheel assemblies coupled to the frame, each swiveling wheel assembly of the set of swiveling wheel assemblies configured to swivel about a vertical axis associated with the frame, and at least one traction wheel assembly coupled to the frame. The at least one traction wheel assembly has a non-swiveling wheel assembly configured to remain rotationally stationary relative to the vertical axis associated with the frame. The at least one traction wheel assembly has a wheel-positioning assembly disposed in positional communication with the non-swiveling wheel assembly. The wheel-positioning assembly is configured to position the non-swiveling wheel assembly between a retracted position relative to the frame and an extended position relative to the frame.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view of a preferred embodiment of a rolling base section of a mobile cart base;

FIG. 2 is a perspective view of the rolling base section of FIG. 1, showing the addition of front and rear cover members;

FIG. 3 is a perspective view of the rolling base section of FIG. 2, showing the addition of corner cover members;

FIG. 4 is a perspective view of the rolling base section of FIG. 3, showing the addition of a manually-engaged traction wheel;

FIG. 5 is a perspective view of the rolling base section of FIG. 4, showing the addition of battery cell compartments;

FIG. 6 is a perspective view of the rolling base section of FIG. 5, showing the addition of a spring assembly and an electrical interconnect assembly;

FIG. 7 is a perspective view of the rolling base section of FIG. 6, showing the addition of battery cells;

FIG. 8A is a perspective view of the rolling base section of FIG. 7, showing the addition of a top cover member;

FIG. 8B is a perspective view of a mobile cart;

FIG. 9A is perspective view of a wheel assembly for a manually-engaged traction wheel;

FIG. 9B is an exploded view of the components of the wheel assembly of FIG. 9A;

FIG. 9C is a perspective view of a traction wheel housing for a manually-engaged traction wheel;

FIG. 9D is an exploded view of the components of the traction wheel housing of FIG. 9C;

FIG. 9E is a side view of a manually-engaged traction wheel;

FIG. 9F is a front view of the manually-engaged traction wheel of FIG. 9E;

FIG. 9G is an exploded view of the components of a cam and lever assembly of the manually-engaged traction wheel of FIG. 9E;

FIG. 9H is an exploded view of the components of the manually-engaged traction wheel of FIG. 9E;

FIG. 10A is a perspective view of a wheel assembly for an automatically-engaged traction wheel;

FIG. 10B is an exploded view of the components of the wheel assembly of FIG. 10A;

FIG. 10C is a front view of a motor and shaft assembly for an automatically-engaged traction wheel;

FIG. 10D is a side view of the motor and shaft assembly of FIG. 10C;

FIG. 10E is an exploded view of the components of the motor and shaft assembly of FIG. 10C;

FIG. 10F is an exploded view of the motor electrical assembly of the motor and shaft assembly of FIG. 10E;

FIG. 10G is a perspective view of an automatically-engaged traction wheel;

FIG. 10H is an exploded view of the components of the automatically-engaged traction wheel of FIG. 10G;

FIG. 10I is an exploded view of a traction wheel housing for an automatically-engaged traction wheel;

FIG. 11 illustrates an exploded perspective view of a wheel assembly;

FIG. 12 illustrates an assembled perspective view of the wheel assembly of FIG. 11;

FIG. 13 illustrates an exploded perspective view of a traction wheel assembly;

FIG. 14 illustrates an assembled perspective view of the traction wheel assembly of FIG. 13;

FIG. 15 illustrates an exploded perspective view of a cam mechanism;

FIG. 16 illustrates a perspective view of a traction wheel assembly disposed in a retracted state;

FIG. 17 is a side view of the traction wheel assembly of FIG. 16;

FIG. 18 is a front view of the traction wheel assembly of FIG. 16;

FIG. 19 is a front view of the traction wheel assembly of disposed in an expanded state;

FIG. 20 illustrates a front view of the cam mechanism of FIG. 15;

FIG. 21 illustrates a front schematic view of the cam mechanism disposed in a first position;

FIG. 22 illustrates a front schematic view of the cam mechanism disposed in a second position;

FIG. 23 illustrates an exploded view of a linearly translating traction assembly, according to one arrangement;

FIG. 24 illustrates an exploded view of a cam assembly of FIG. 23, according to one arrangement; and

FIG. 25 illustrates an exploded view of a linearly traction assembly relative to a frame, according to one arrangement.

### DETAILED DESCRIPTION

### I. Mobile Cart Base

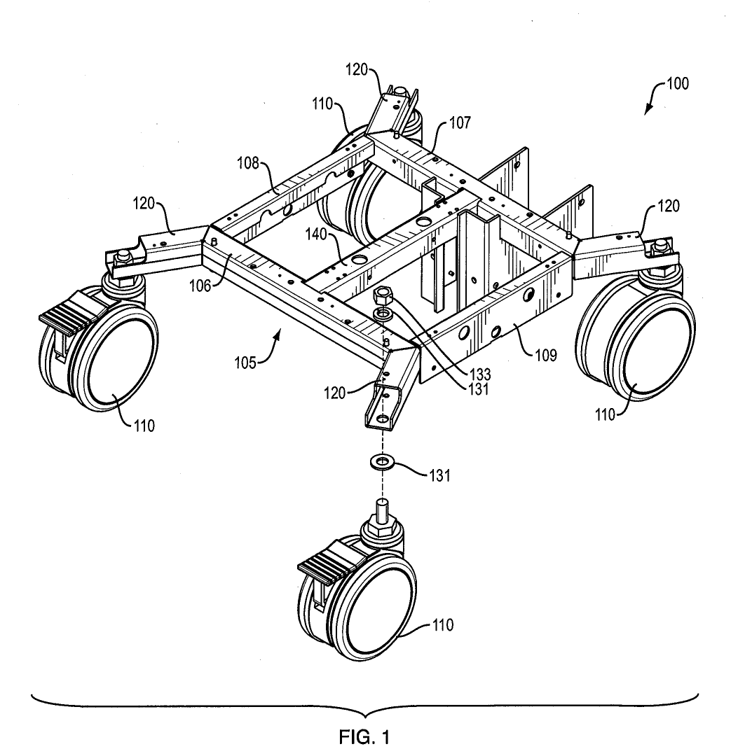

With reference to FIGS. 1 through 8, in a preferred embodiment, mobile cart base 800 comprises a rolling base section 100 that includes a generally rectangular base frame 105 and four omni-directional, optionally locking, swiveling casters or wheel assemblies 110. In alternate embodiments, mobile cart base 800 may include a generally elliptical base frame, or a base frame comprising three, four or more sides, and may have two, three or more swiveling wheels.

As shown in FIG. 1, base frame 105 comprises a front frame member 106, a rear frame member 107, two opposing side frame members, left side member 108 and right side member 109, and center frame member 140. In a preferred embodiment, base frame 105 includes four protruding legs 120, one protruding leg located proximate each corner of the base frame 105. Base frame 105 is preferably constructed of metal, although other materials, suitable for accommodating the weight of the mobile cart, are within the scope of the invention. One swiveling caster or wheel 110 is coupled to each protruding leg 120 with washers 131 and nut 133, although other types of connectors or fasteners known in the art may be used. In alternate embodiments, protruding legs 120 are optional, and one swiveling caster or wheel 110 may be coupled directly to each of the corners of base frame 105, or proximate the corners of base frame 105.

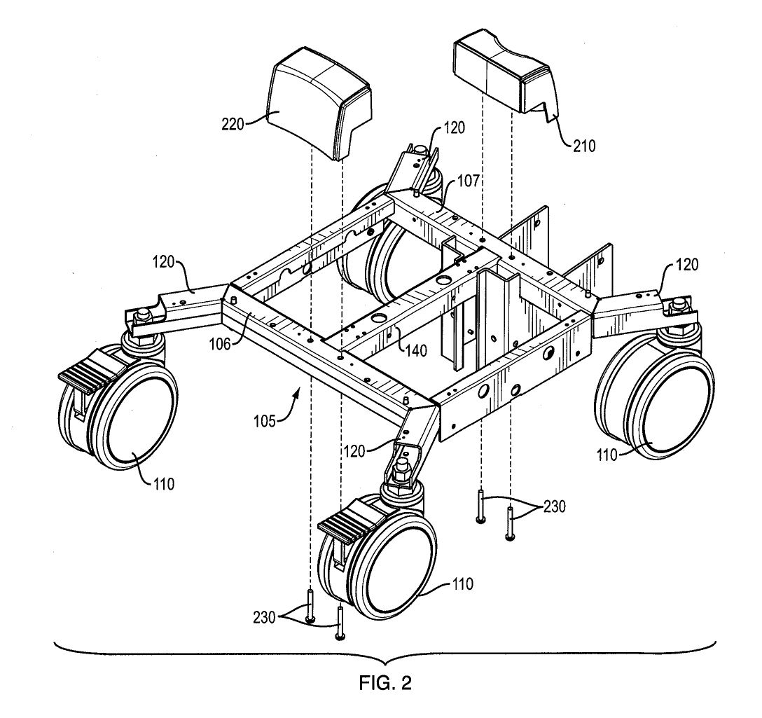

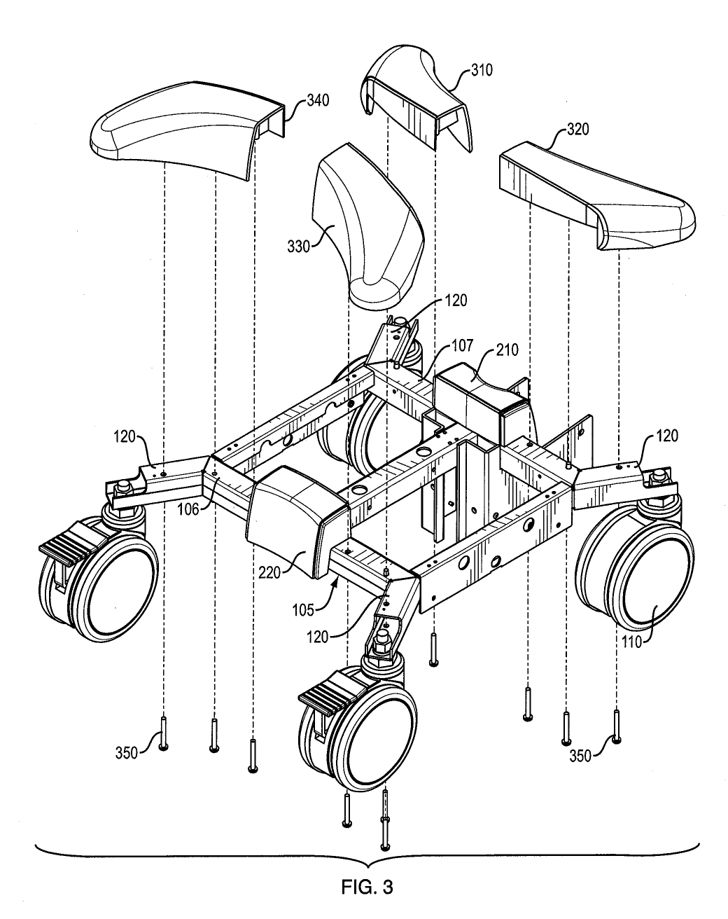

As shown in FIGS. 2 and 3, front cover member 220 is mounted to base frame 105 proximate the center of front frame member 106, and rear cover member 210 is mounted to base frame 105 proximate the center of rear frame member 107 with screws 230, or other types of connectors or fasteners. In a preferred embodiment, front cover member 220 and rear cover member 210 are made of plastic.

As shown in FIGS. 3 and 4, each of the corner cover members 310, 320, 330 and 340 is mounted to base frame 105 proximate each of the corners of base frame 105 with screws 350 or other types of known fasteners or connectors, so as to cover the tops of the protruding legs 120. Once mounted to base frame 105, and as shown in FIG. 4, corner cover members 330 and 340 and front cover member 220 are adapted and configured to cover substantially the entire top of front frame member 106. Similarly, corner cover members 310 and 320 and rear cover member 210 are adapted and configured to cover substantially the entire top of rear frame member 107 once mounted to base frame 105. Corner cover members 310, 320, 330 and 240 are preferably made of plastic.

With reference to FIG. 4, and as described in detail below, manually-engaged traction wheel assembly 990 is mounted to center frame member 140 with screws 410 or other known forms of connectors or fasteners.

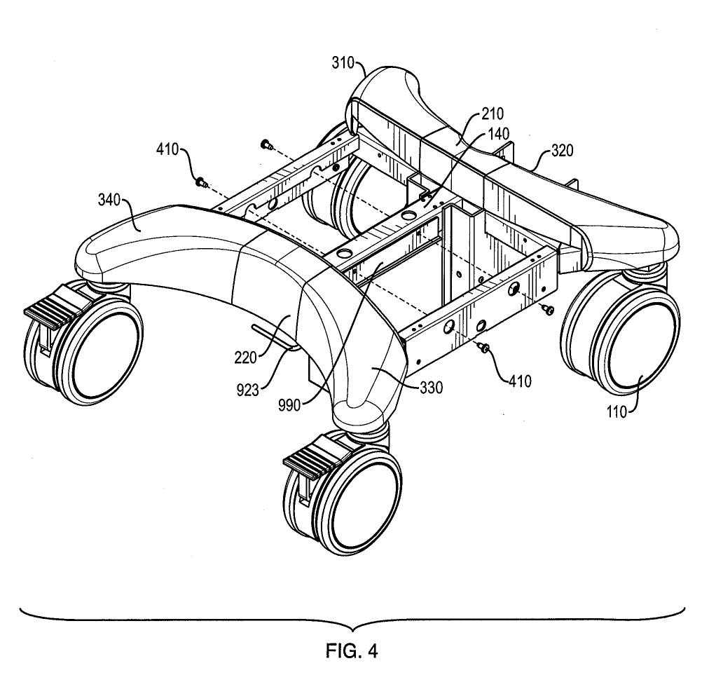

As shown in FIG. 5, optional battery cell compartments 510 and 520 are generally cube-shaped with an open top and a closed bottom, and are adapted to house the battery cells that provide power to the electrical components housed on the mobile cart. Battery cell compartment 510 comprises left and right top flanges, 515 and 516 respectively. Left top flange 515 is adapted to rest on top of at least a portion of the top of left frame member 108, and right top flange 516 is adapted to rest on top of at least a portion of the top of the center frame member 140. Similarly, battery cell 520 comprises left and right top flanges 526 and 527, respectively. Left top flange 526 is adapted to rest on top of at least a portion of the top of the center frame member 140. Right top flange 527 is adapted to rest on top of at least a portion of the top of right frame member 109.

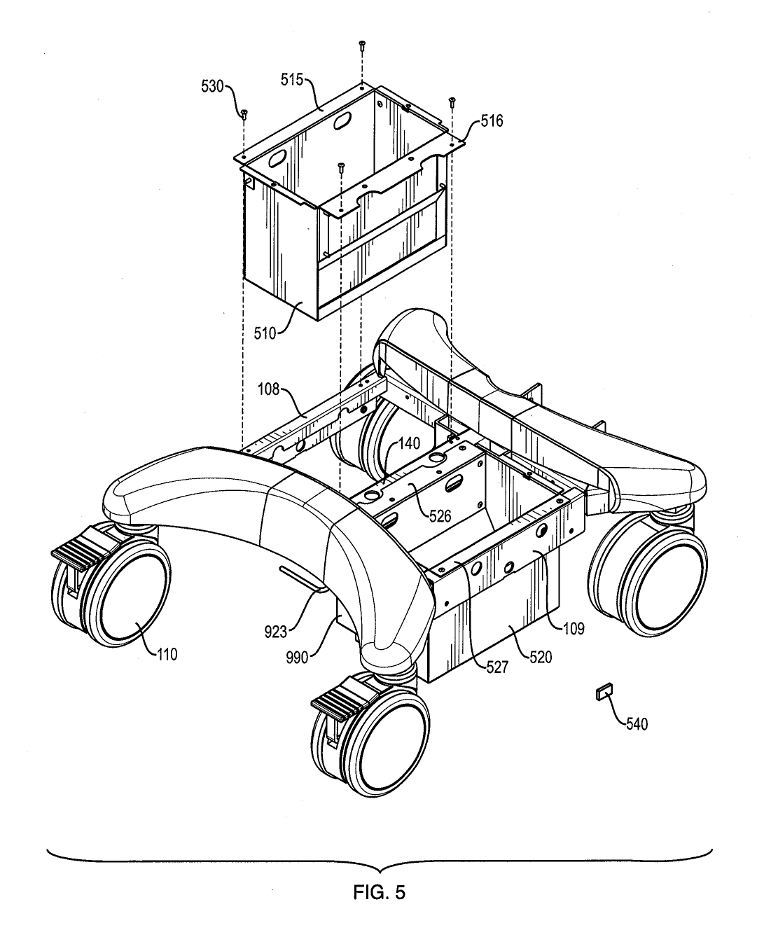

FIG. 6 shows the addition of spring assembly 610 and electrical interconnect assembly 620 to base frame 105. Spring assembly 610 is used to exert a slight downward pressure on the wheel assembly 940 of manually-engaged traction wheel assembly 990, as described in detail below. Spring assembly 610 acts as a shock absorber, allowing wheel assembly 940 to give and still remain in contact with the floor. Electrical interconnect assembly 620 connects the battery cells 710 and 720, which are shown in FIG. 7 and described below.

In a preferred embodiment, spring assembly 610 comprises a bushing 611, a spring 612, a retainer 613 and one more screws or fasteners 614 to couple retainer 613 to center frame member 140. Spring 612 is preferably a compression spring.

In a preferred embodiment, electrical interconnect assembly 620 comprises interconnect board 621, interconnect board housing 622, screws 623 to couple interconnect board 621 to interconnect board housing 622, and screws or fasteners 624 to couple interconnect board housing 622 to center frame member 140. In alternate embodiments, interconnect board 621 includes a connector (not shown) that is used to power an automatically-engaged traction wheel 1010, described in detail below.

As shown in FIG. 7, optional battery cells 710 and 720 are housed in optional battery cell compartments 510 and 520, respectively, and coupled to base frame 105 with screws or fasteners 730.

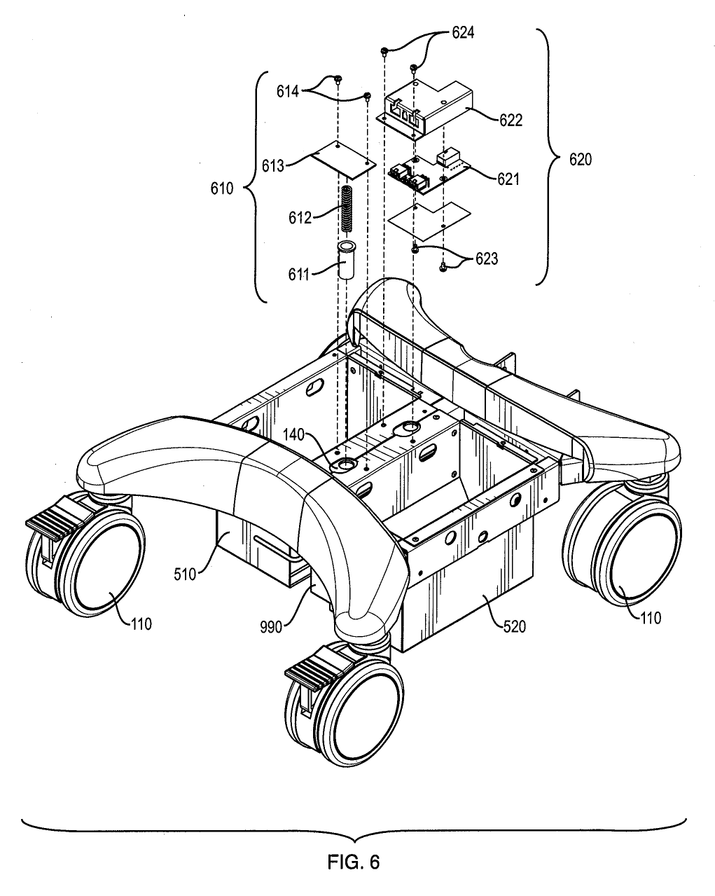

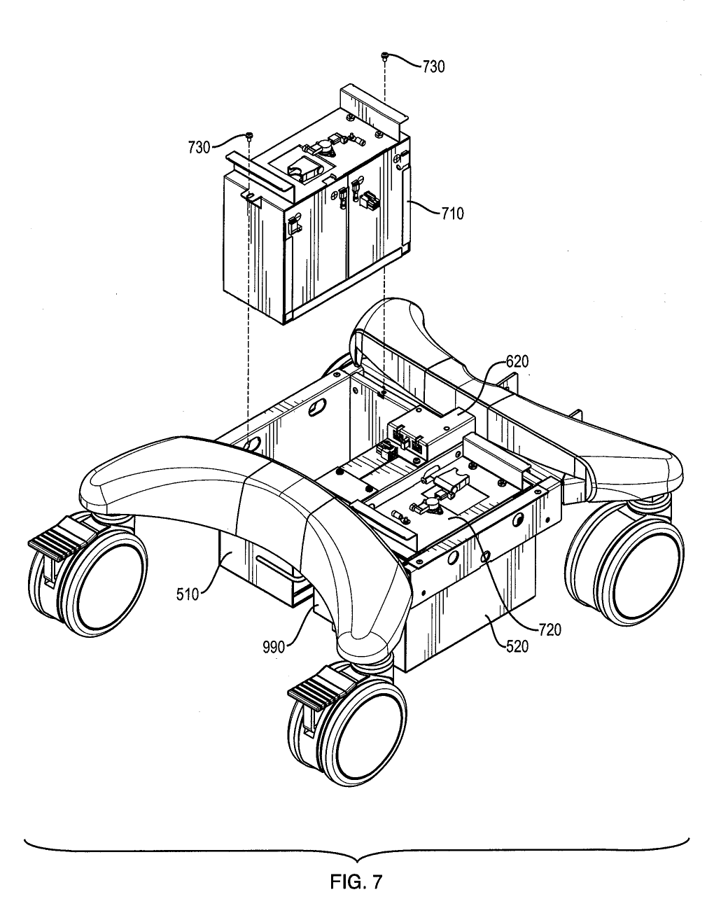

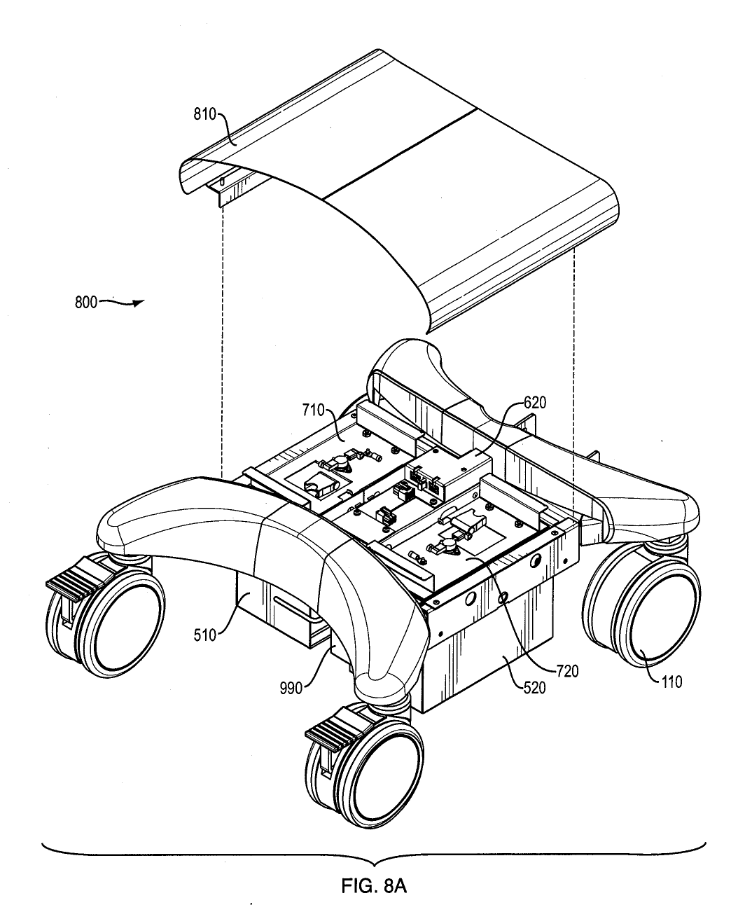

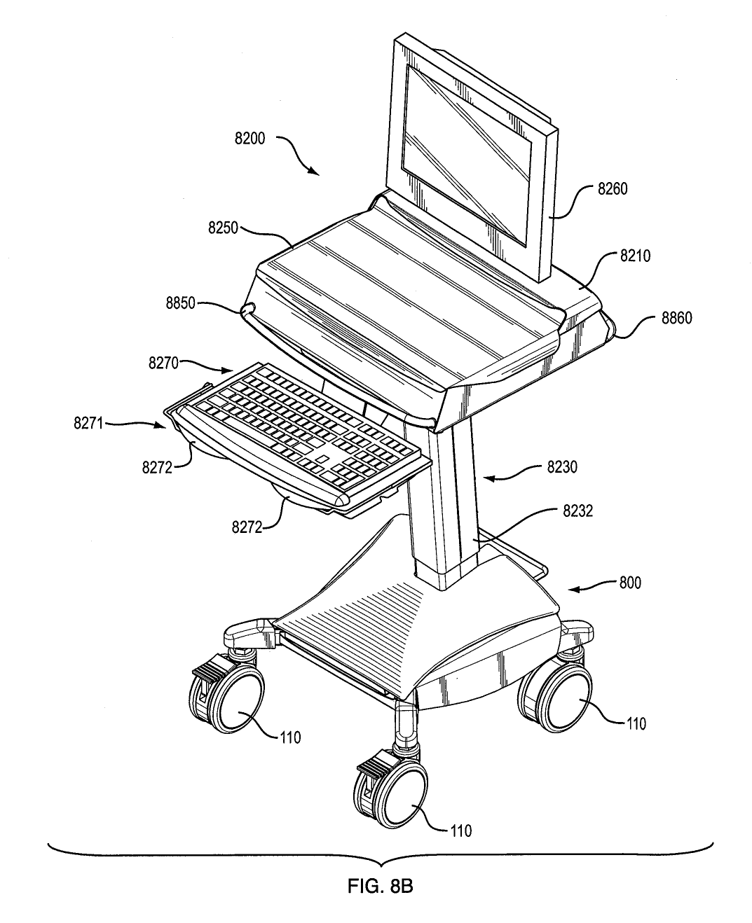

FIG. 8A shows the addition of top cover member 810, which completes a preferred embodiment of the mobile cart base 800. Top cover member 810 is preferably made of plastic.

In an alternate embodiment, the base frame 105 may not include center frame member 140, battery cell compartments 510 and 520, and/or battery cells 710 and 720, and the manually-engaged traction wheel assembly 990 may be mounted to either or both of the left and right frame members 108 and 109.

In one non-limiting embodiment, mobile cart base 800 may be used as the rolling base section for a mobile cart, such as mobile cart 8200 shown in FIG. 8B. Mobile cart 8200 may comprise a mobile cart base 800, upper working section 8210, and intermediate section 8230. Intermediate section 8230 may comprise a length-adjustable upwardly-extending post 8232, which allows the height of upper working section 8210 to be adjusted. Upper working section 8210 may include a keyboard support 8271 adapted to carry keyboard 8270, and one or two retractable mouse trays 8272. Mobile cart 8200 may also carry a computer (not shown), such as by a bracket coupled to upper working section 8210. Upper working section 8210 may also carry a computer monitor 8260 and a storage compartment 8250. Mobile cart 8200 may also include a front projecting handle 8850 and a rear projecting handle 8860 to allow a user to roll the mobile cart.

### II. Manually-Engaged Traction Wheel

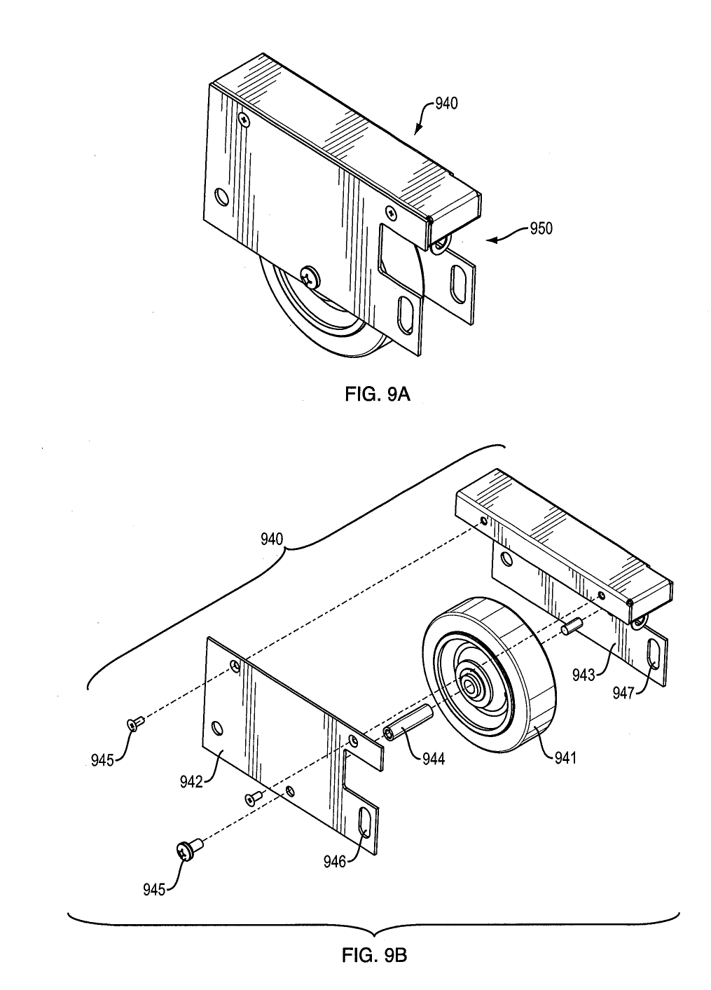

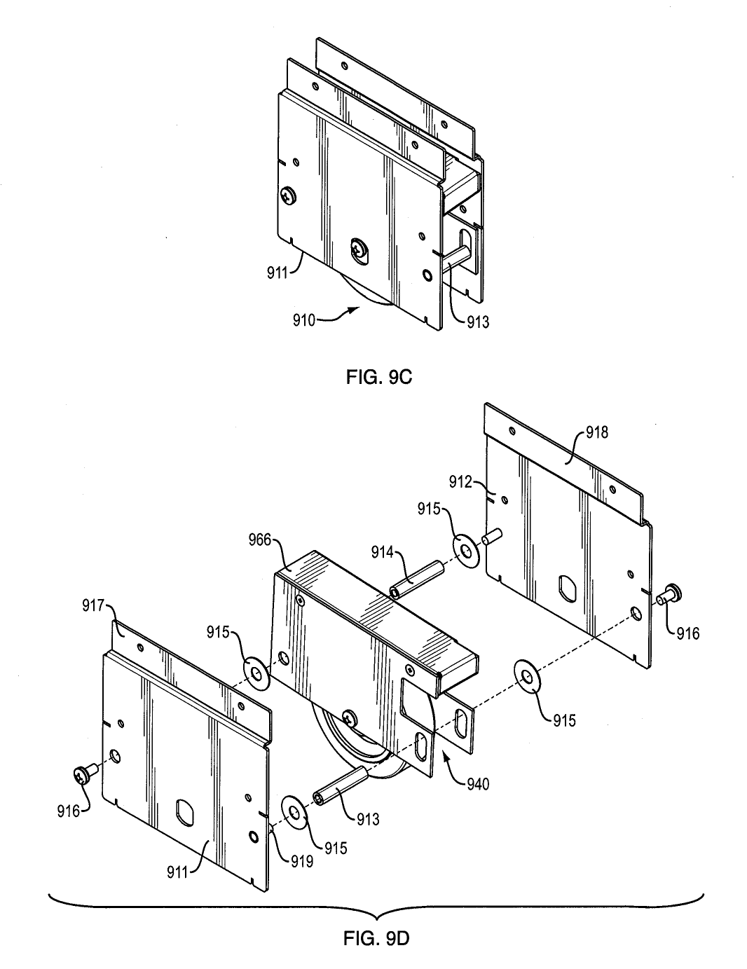

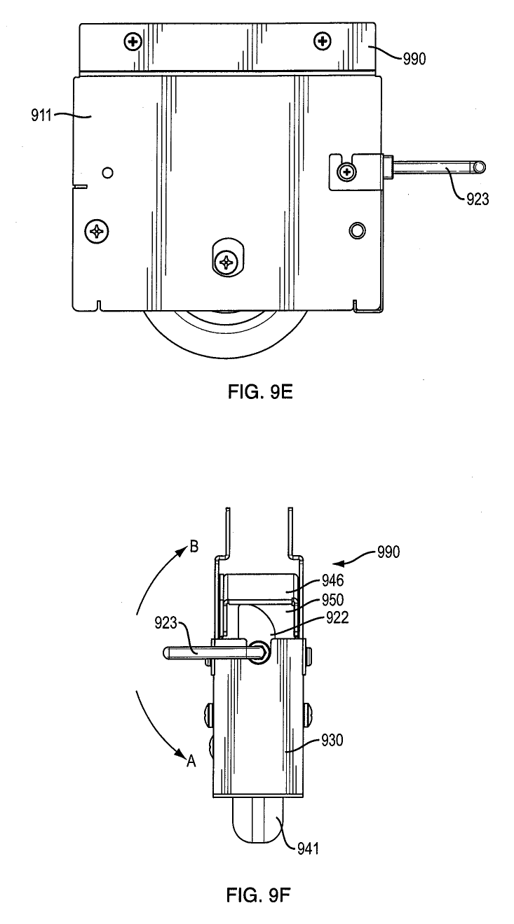

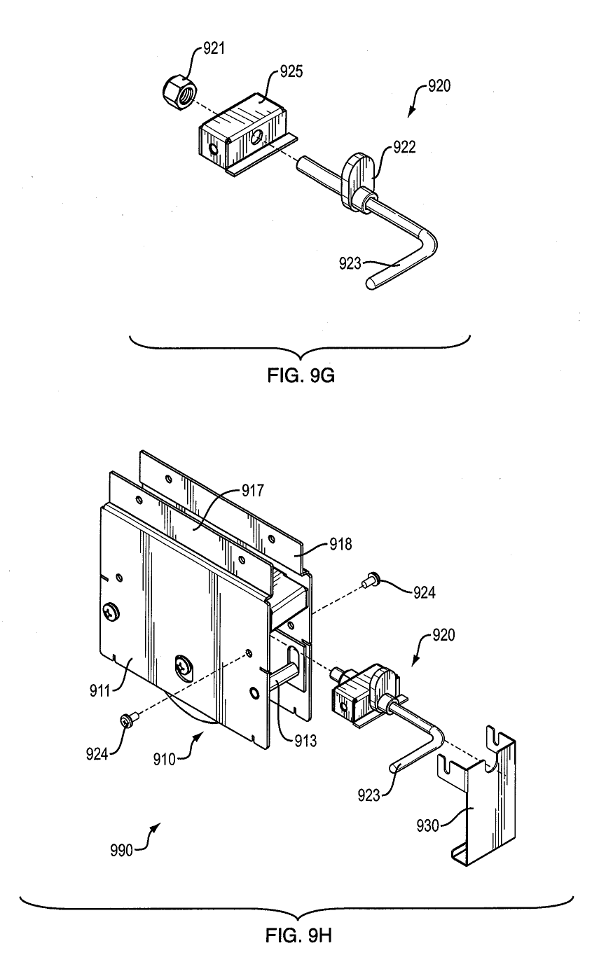

The details of manually-engaged traction wheel assembly 990, shown previously in FIGS. 4 through 7 and 8A, are shown in FIGS. 9A through 9H. With reference to FIGS. 9E, 9F, and 9H, manually-engaged traction wheel assembly 990 comprises traction wheel housing 910, cam and lever wheel-positioning assembly 920, and cover plate 930. As shown in FIG. 9G, wheel-positioning assembly 920 comprises a cam 922, block 925, and a lever 923, coupled together with connector or fastener 921.

As shown in FIGS. 9C and 9D, traction wheel housing 910 comprises wheel assembly 940 and generally rectangular left and right assembly plates 911 and 912, respectively. Left assembly plate 911 and right assembly plate 912 each have an upper vertical flange, 917 and 918, respectively, that are adapted to couple manually-engaged traction wheel assembly 990 to center frame member 140, as shown in FIG. 4. Wheel assembly 940 is sandwiched between and coupled to left assembly plate 911 and right assembly plate 912 with bushings 913 and 914, washers 915, and screws 916, or other known types of connectors or fasteners.

With reference to FIGS. 9A and 9B, wheel assembly 940 comprises wheel 941, and left and right wheel brackets 942 and 943, respectively. Left and right wheel brackets 942 and 943 form a housing for wheel 941. Wheel 941 is sandwiched between and coupled to left wheel bracket 942 and right wheel bracket 943 with bushing 944 and screws or fasteners 945. Bushing 944 is centered through wheel 941, and allows wheel 941 to rotate.

Left wheel bracket 942 and right wheel bracket 943 each define an elongated slot, 946 and 947, respectively, through which bushing 913 is inserted and coupled to post 919, as shown in FIGS. 9B, 9C and 9D. This configuration allows wheel assembly 940 to move up and down relative to the left and right assembly plates, 911 and 912, of the traction wheel housing 910. The range of movement of wheel assembly 940 is guided and limited by elongated slots 946 and 947.

When assembled, wheel assembly 940 defines a top member 966 and a notch 950. As shown in FIG. 9F, notch 950 accommodates cam and lever assembly 920. When cam and lever assembly 920 is engaged, and as shown in FIG. 9F, cam 922 is in contact with top member 966. Conversely, when cam and lever assembly 920 is disengaged, cam 922 is not in contact with top member 966.

The wheel assembly 940 is lowered or raised by lever 923. When lever 923 is in a first position, for example a generally horizontal position, as shown in FIGS. 9E and 9F, cam and lever assembly 920 is engaged, and wheel assembly 940 is raised, such that wheel 941 is raised above and not in contact with the floor or other surface. When lever 923 is moved up or down ninety degrees to a second position, for example in the direction of arrow A or arrow B, cam and lever assembly 920 is disengaged, and wheel assembly 940 is lowered, such that wheel 941 is in contact with the floor or other surface.

### III. Automatically-Engaged Traction Wheel

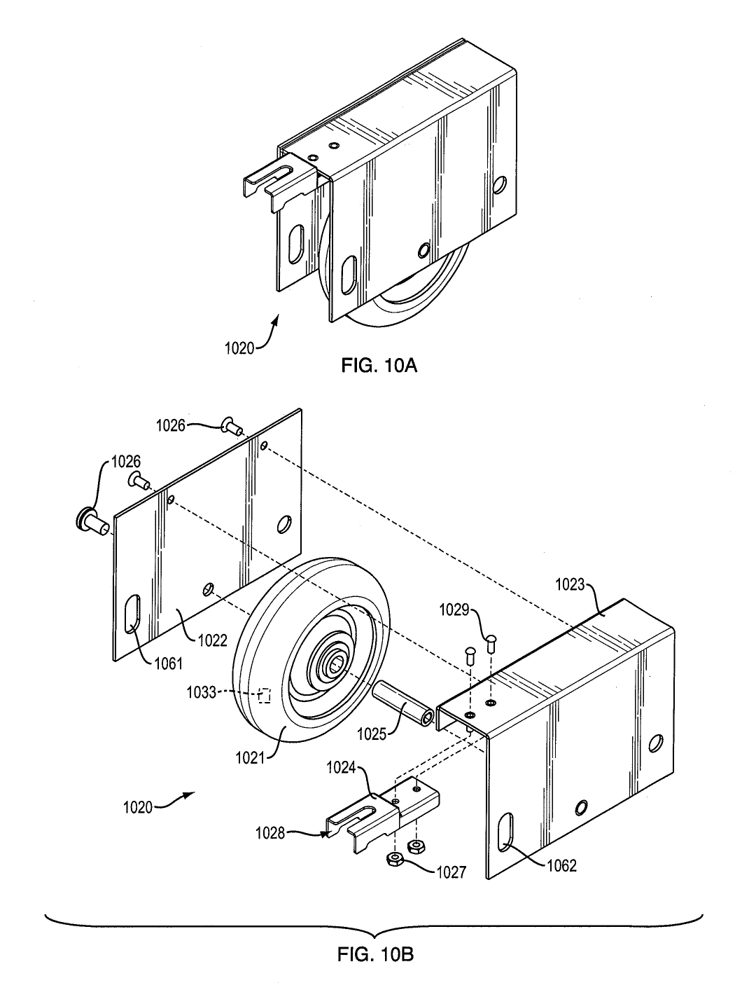

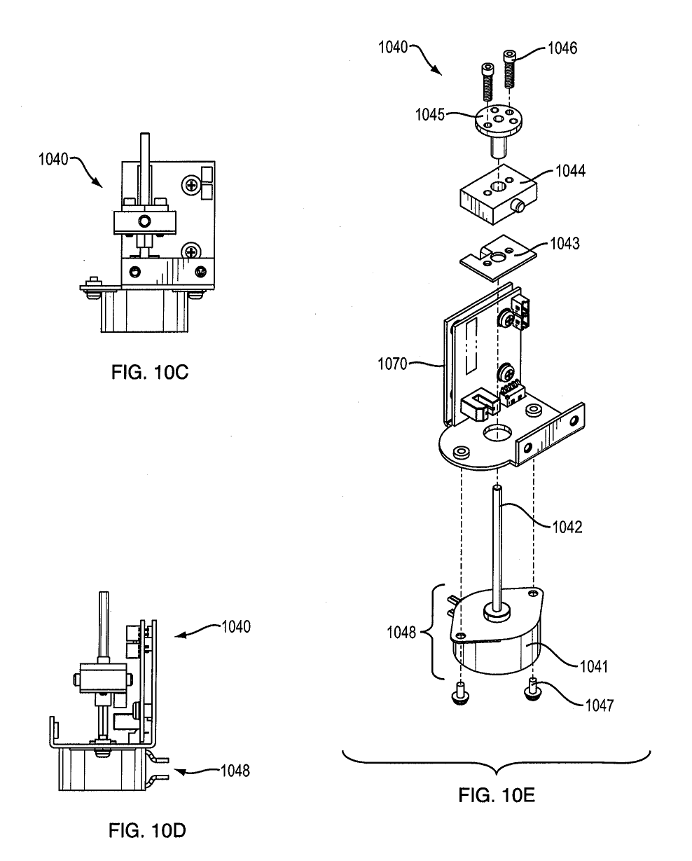

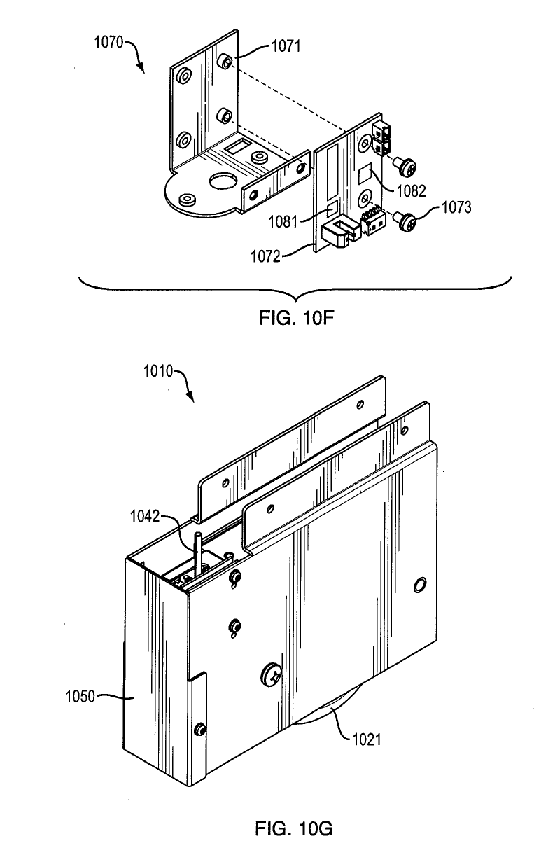

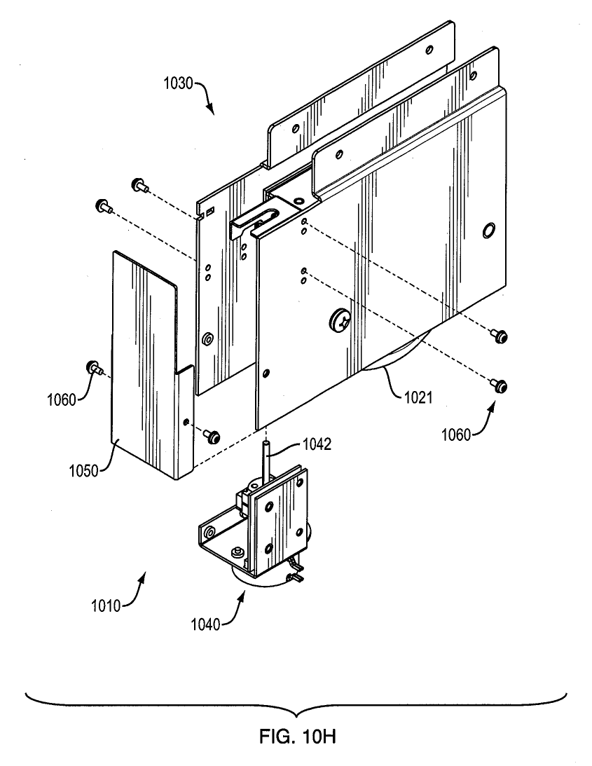

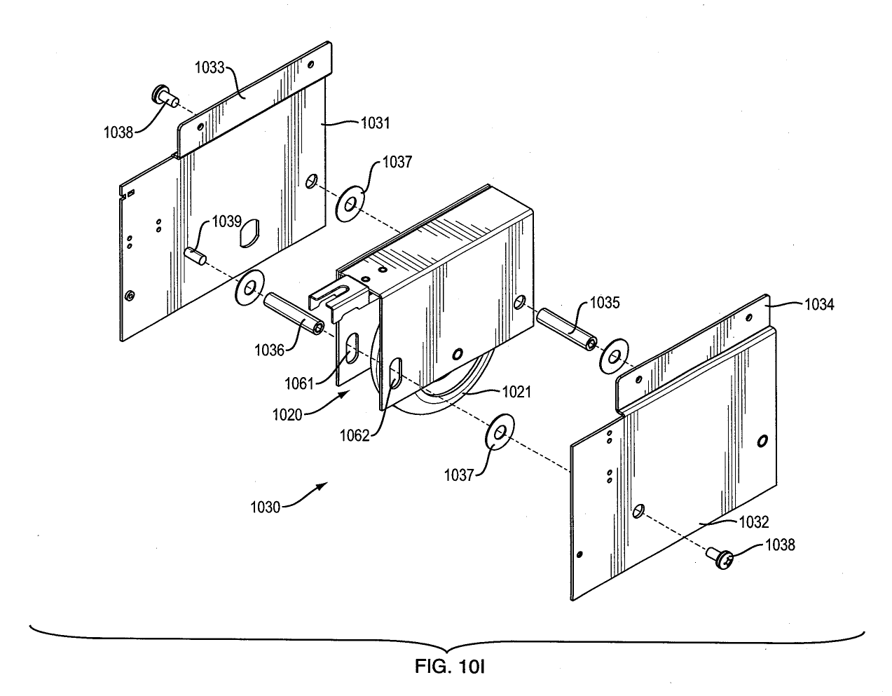

The details of automatically-engaged traction wheel 1010 are shown in FIGS. 10A through 10I. With reference to FIGS. 10H and 10G, automatically-engaged traction wheel 1010 comprises traction wheel housing 1030, motor and shaft wheel-positioning assembly 1040, and cover plate 1050, and is coupled together with screws 1060 or other forms of known connectors or fasteners.

As shown in FIG. 10I, traction wheel housing 1030 comprises wheel assembly 1020 and generally rectangular left and right assembly plates 1031 and 1032, respectively. Left assembly plate 1031 and right assembly plate 1032 each have an upper vertical flange, 1033 and 1034, respectively. Vertical flanges 1033 and 1034 are adapted to couple automatically-engaged traction wheel 1010 to center frame member 140 of base frame 105, similar to the manner in which manually-engaged traction wheel assembly 990 is coupled to center frame member 140, as shown in FIG. 4. Wheel assembly 1020 is sandwiched between and coupled to left assembly plate 1031 and right assembly plate 1032 with bushings 1035 and 1036, washers 1037, and screws 1038, or other known types of connectors or fasteners.

With reference to FIGS. 10A and 10B, wheel assembly 1020 comprises wheel 1021, left and right wheel brackets 1022 and 1023, respectively, and motor engagement member 1024. Motor engagement member 1024 defines a notch 1028. Left and right wheel brackets 1022 and 1023 form a housing for wheel 1021. Wheel 1021 is sandwiched between and coupled to left wheel bracket 1022 and right wheel bracket 1023 with bushing 1025 and screws or fasteners 1026. Motor engagement member is coupled to right wheel bracket 1023 with screws 1029 and nuts 1027, or other known forms of connectors. Bushing 1025 is centered through wheel 1021, and allows wheel 1021 to rotate. When assembled, threaded shaft 1042 of motor and shaft assembly 1040, described below, extends through notch 1028.

Left wheel bracket 1022 and right wheel bracket 1023 each define an elongated slot, 1061 and 1062, respectively, through which bushing 1036 is inserted and coupled to 1039, as shown in FIG. 10I. This configuration allows wheel assembly 1020 to move up and down relative to the left and right assembly plates, 1031 and 1032, of the traction wheel housing 1030. The range of movement of wheel assembly 1020 is guided and limited by elongated slots 1061 and 1062.

Motor and shaft wheel-positioning assembly 1040 is shown in FIGS. 10C through 10F. With reference to FIG. 10E, motor and shaft assembly 1040 comprises motor 1041, threaded shaft 1042, motor electrical assembly 1070, bracket 1043, connector block 1044 and collar 1045, and is coupled together with screws or fasteners 1046 and 1047. Motor electrical assembly 1070, bracket 1043, connector block 1044 and collar 1045 ride up and down as the threaded shaft 1042 turns. With reference to FIG. 10F, motor electrical assembly 1070 comprises circuit board 1072 and housing 1071, which are coupled together with screws or fasteners 1073.

In a preferred embodiment, automatically-engaged traction wheel 1010 is motion sensitive. Circuit board 1072 includes a Hall Effect sensor 1082 that controls motor 1041. Hall Effect sensor 1082 responds to a small magnet 1083 embedded in wheel 1021, as shown in FIG. 10A. When the mobile cart base is in motion and wheel 1021 is spinning, the magnet 1083 is effectively sending an “on/off” signal to the Hall Effect sensor 1082.

When wheel 1021 is not spinning, the Hall Effect sensor 1082 does not detect the “on/off” signal from magnet 1083, and motor 1041 turns threaded shaft 1042 to a first position such that wheel assembly 1020 is raised relative to the traction wheel housing 1030 and wheel 1021 is no longer in contact with the floor or other surface. When wheel 1021 is spinning, the Hall Effect sensor 1082 detects the “on/off” signal from the magnet 1083, and motor 1041 turns threaded shaft 1042 to a second position such that wheel assembly 1020 is lowered relative to the traction wheel housing 1030 and wheel 1021 is in contact with the floor or other surface.

Circuit board 1072 also includes a vibration sensor chip 1081. When the mobile cart is in motion, the vibration sensor chip 1081 causes motor 1041 to turn threaded shaft 1042 so as to lower wheel assembly 1020, such that wheel 1021 is in contact with the floor or other surface.

In an alternate embodiment, automatically-engaged traction wheel 1010 is operated by an on/off switch or button, which may be located on the mobile cart base 800, or the upper working section 8210 or the intermediate section 8230 of the mobile cart 8200.

Motor 1041 receives power from the on-board battery cells 710 and 720 through interconnect board 621, shown in FIG. 6, through two terminals 1048 located on the outer side of motor 1041, shown in FIGS. 10D and 10E.

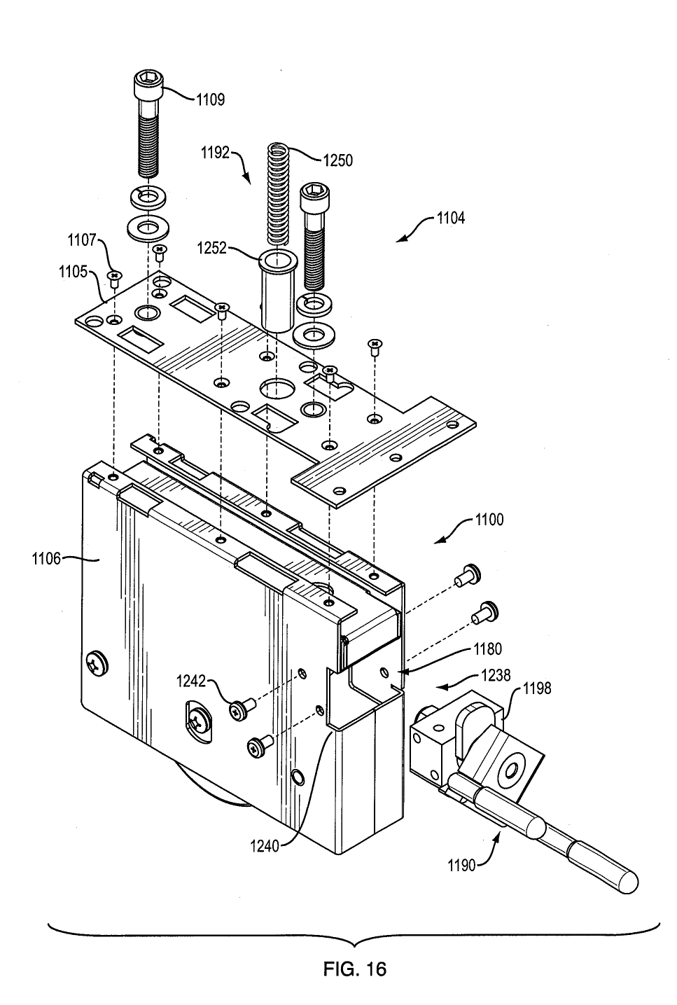

As indicated above, and with reference to FIG. 4 and FIGS. 9A-9H, a base 800, such as for a mobile cart, includes a frame 105, a set of swiveling wheel assemblies 110 mounted to the frame 105, and a manually-engaged traction wheel assembly 990 mounted to the frame 105 at substantially a center location of the frame 105. As indicated above, the traction wheel assembly 990 includes a cam and lever assembly 920 configured to manually position the wheel assembly 940 between a retracted position (i.e., the wheel 941 is raised above and not in contact with the floor or other surface) and an extended position (i.e., the wheel 941 substantially contacts the floor or other surface) relative to the frame 105. Such description is by way of example only. In one arrangement, the mobile cart base 800 includes a traction wheel assembly 1100 configured with an automated wheel extension mechanism, such as illustrated in FIGS. 16-19 and as described below.

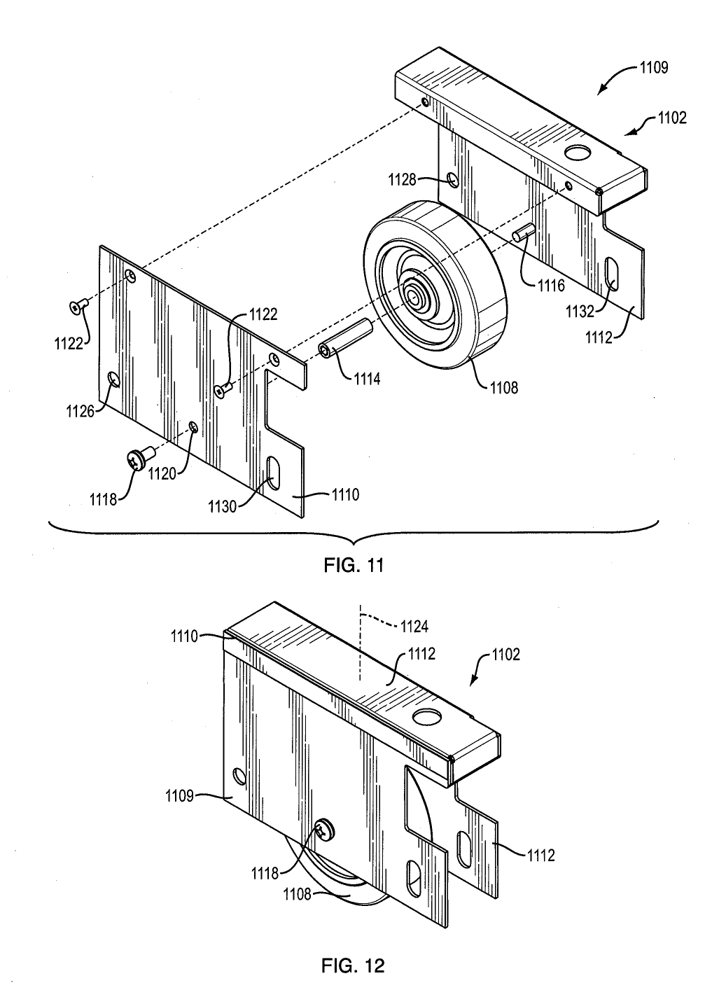

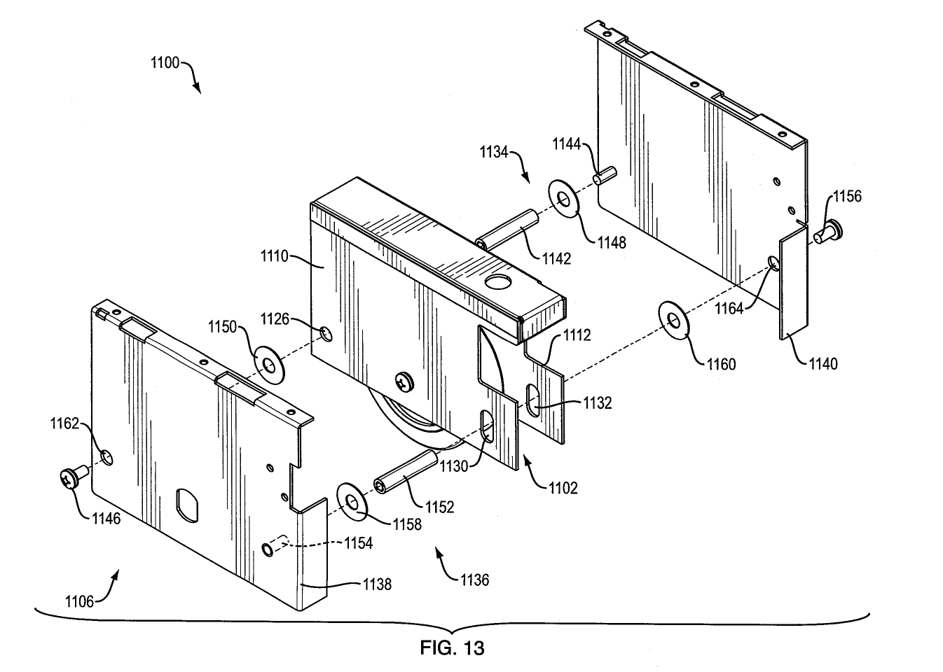

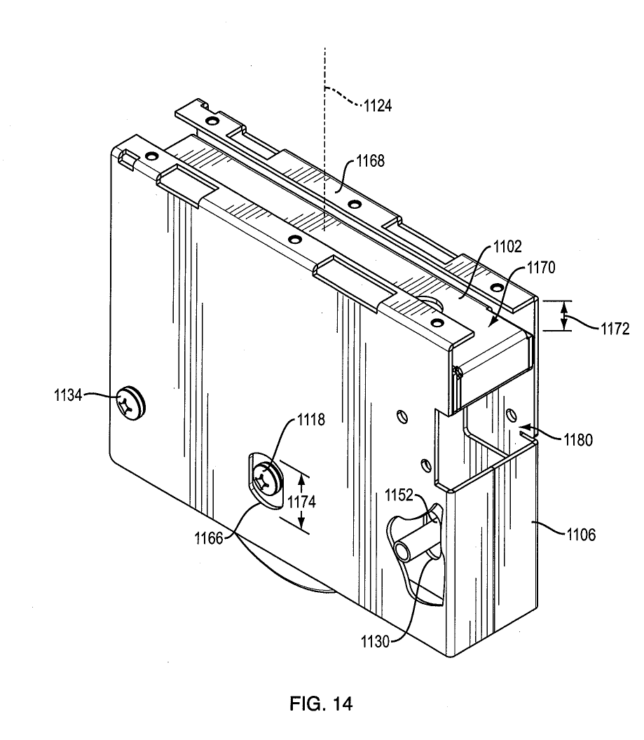

In one arrangement, the traction wheel assembly 1100 includes a wheel assembly 1102, as referenced in FIGS. 11-14, a wheel-positioning assembly 1104, as referenced in FIG. 16, and a traction wheel assembly housing 1106, as referenced in FIGS. 13 and 14.

With reference to FIGS. 11 and 12, the wheel assembly 1102 includes a wheel 1108 captured between a wheel housing 1109 having a first wheel bracket 1110 and a second wheel bracket 1112. As indicated, the wheel 1108 is rotatably disposed on a bushing or axle 1114 which, in turn, is secured to the first and second wheel brackets 1110, 1112 via a mounting assembly. While the mounting assembly can be configured in a variety of ways, in one arrangement, the mounting assembly includes a support element 1116 extending from the second wheel bracket 1112 and a fastener 1118 configured to secure the bushing 1114 to the first wheel bracket 1110 via opening 1120. The first wheel bracket 1110 is coupled to the second wheel bracket 1112 by way of fasteners 1122 to secure the wheel 1108 there between.

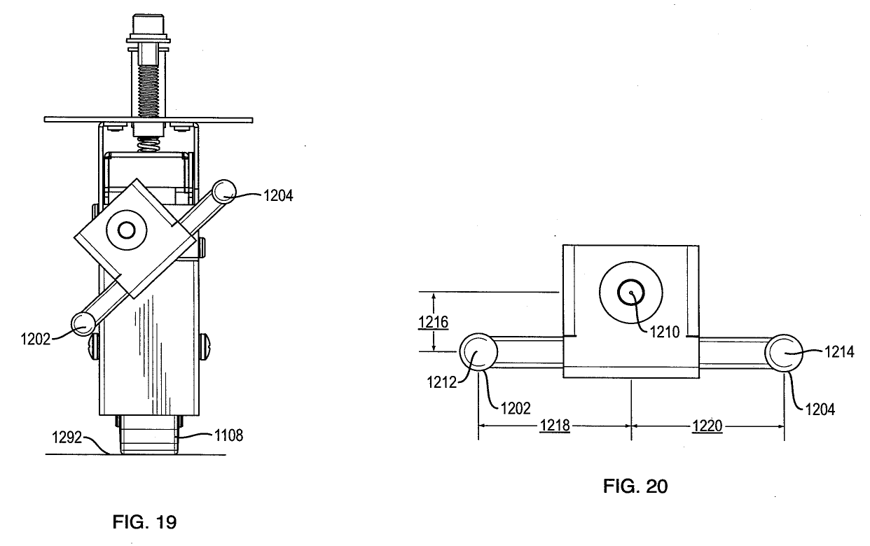

The wheel assembly 1102 is configured as a non-swiveling wheel assembly relative to the frame 104 of the base 800. For example, when mounted to the frame 104 by the traction wheel assembly housing 1106, the wheel assembly 1102 is configured to remain rotationally stationary relative to a vertical axis 1124 associated with the frame 104. Such a stationary configuration allows the base 800 to pivot on the wheel 1108 when the wheel assembly 1102 is positioned in an extended position relative to the frame 1104, such as indicated in FIG. 19.

In one arrangement, the wheel assembly 1102 is configured to pivotably mount to the traction wheel assembly housing 1106. For example, the first and second wheel brackets 1110, 1112 each define a corresponding pivot opening 1126, 1128 and slotted opening 1130, 1132. With reference to FIGS. 13 and 14, the wheel assembly 1102 is captured between a first housing element 1138 and a second housing element 1140 of the traction wheel assembly housing 1106. The wheel assembly 1102, in turn, is coupled to a pivot mounting assembly 1134 of the traction wheel assembly housing 1106 via the pivot opening 1126, 1128 and to a slot mounting assembly 1136 of the traction wheel assembly housing 1106 via the slotted openings 1130, 1132.

For example, the pivot mounting assembly 1134 includes an axle or bushing 1142 that defines a lumen extending along a longitudinal axis between a first end and a second end of the bushing 1142. The pivot mounting assembly 1134 further includes a support element 1144 extending from the second housing element 1140, a fastener 1146, and bearings 1148, 1150. Additionally, the slot mounting assembly 1136 can include a bushing 1152 that defines a lumen extending along a longitudinal axis between a first end and a second end of the bushing 1152, a support element 1154 extending from the first housing element 1138, a fastener 1146, and bearings 1158, 1160.

During an assembly process, an assembler inserts the bushing 1142 through the pivot openings 1126, 1128 of the wheel assembly 1102 and disposes bearings 1148, 1150 on the first and second ends of the bushing 1142 extending from the first and second wheel brackets 1110, 1112. The assembler inserts the support element 1144 into the lumen at the first end of the bushing 1142 and inserts the fastener 1146 into the lumen at the second, opposing end of the bushing 1142 via opening 1162 to pivotably secure the pivot mounting assembly 1134 to the wheel assembly 1102. The assembler also inserts the bushing 1152 through the slotted openings 1130, 1132 of the wheel assembly 1102 and disposes bearings 1158, 1160 on the first and second ends of the bushing 1152 extending from the first and second wheel brackets 1110, 1112. The assembler then inserts the support element 1154 into the lumen at the second end of the bushing 1152 and inserts the fastener 1156 into the lumen at the first, opposing end of the bushing 1152 via opening 1164 to pivotably secure the slot mounting assembly 1136 to the wheel assembly 1102. With reference to FIG. 16, the assembler can then mount the traction wheel assembly housing 1106 to a frame 104 by attaching a mounting plate 1105 to a traction wheel assembly housing mounting portion 1168 via fasteners 1107 and by attaching the mounting plate 1105 to the frame via fasteners 1109

Returning to FIG. 14, with such a configuration of the traction wheel assembly housing 1106, the traction wheel assembly housing 1106 is configured to laterally and rotationally constrain the wheel assembly 1102 relative to a vertical axis 1124 associated with a corresponding frame (not shown) but allow the wheel assembly 1102 to pivot relative to the frame. For example, in response to activation of the wheel-positioning assembly 1104, the wheel assembly 1102 pivots about the pivot mounting assembly 1134 of traction wheel assembly housing 1106. As the wheel assembly 1102 pivots about the pivot mounting assembly 1134, the fastener 1118 travels within a slot 1166 defined by the traction wheel assembly housing 1106 and the slotted opening 1130, 1132 of the first and second wheel brackets 1110, 1112 slots 1130, 1132 translate relative to the bushing 1152 of the slot mounting assembly 1136, as indicated in the partial cutaway view.

Pivoting of the wheel assembly 1102 can be constrained by a variety of stops associated with the traction wheel assembly housing 1106. In one arrangement, the rotation or range of motion of the wheel assembly 1102 can constrained by the traction wheel assembly housing mounting portion 1168 of the traction wheel assembly housing 1106. For example, a top portion 1170 of the wheel assembly 1102 abuts the traction wheel assembly housing mounting portion 1168 when placed in a retracted position thereby minimizing the distance 1172 that the wheel assembly 1102 can travel during pivoting. In one arrangement, the range of pivotal movement of wheel assembly 1102 between the retracted position and the extended position can also be limited by a length of the slotted openings 1130, 1132 relative to the bushing 152 or by length 1174 of the slot 1166 defined by the traction wheel assembly housing 1106.

As indicated above, with reference to FIG. 16, the traction wheel assembly 1100 includes a wheel positioning assembly 1104. The wheel-positioning assembly 1104 is disposed in positional communication with the wheel assembly 1102 and is configured to position the wheel assembly 1102 between a retracted position relative to the frame 104, as indicated in FIG. 18 and an extended position relative to the frame 104, as indicated in FIG. 19. While the wheel-positioning assembly 1104 can be configured in a variety of ways, in one arrangement and as will be discussed in detail below, the wheel-positioning assembly 1104 includes a cam mechanism 1190 and a spring mechanism 1192.

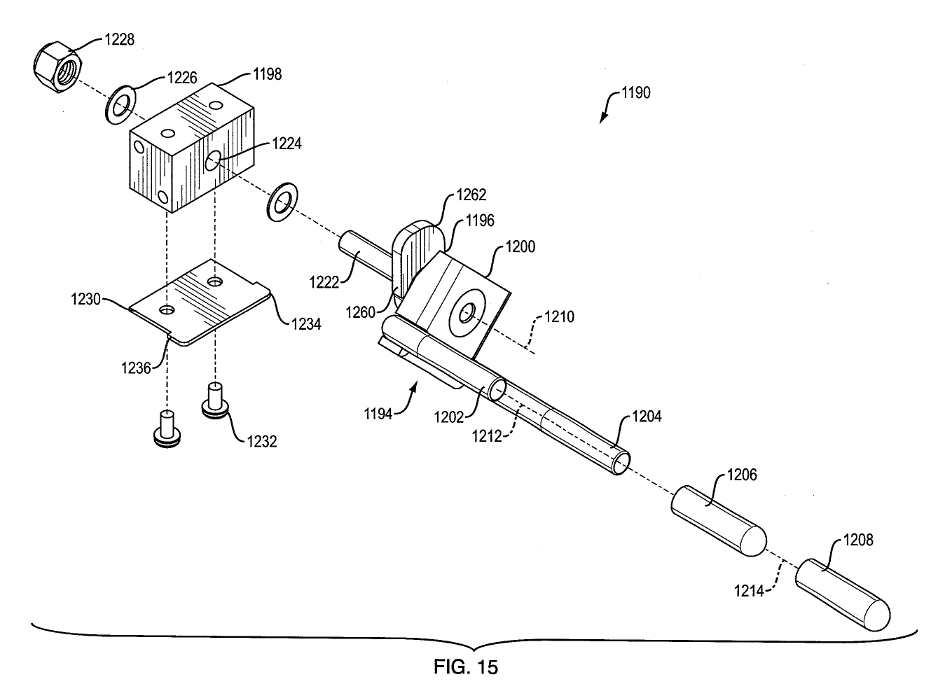

The cam mechanism 1190 is configured to maintain the non-swiveling wheel assembly 1102 in one of the retracted position and the extended position relative to the frame 104. As illustrated in FIG. 15, the cam mechanism 1190 includes an actuator 1194, coupled to a cam element 1196, and a support structure 1198.

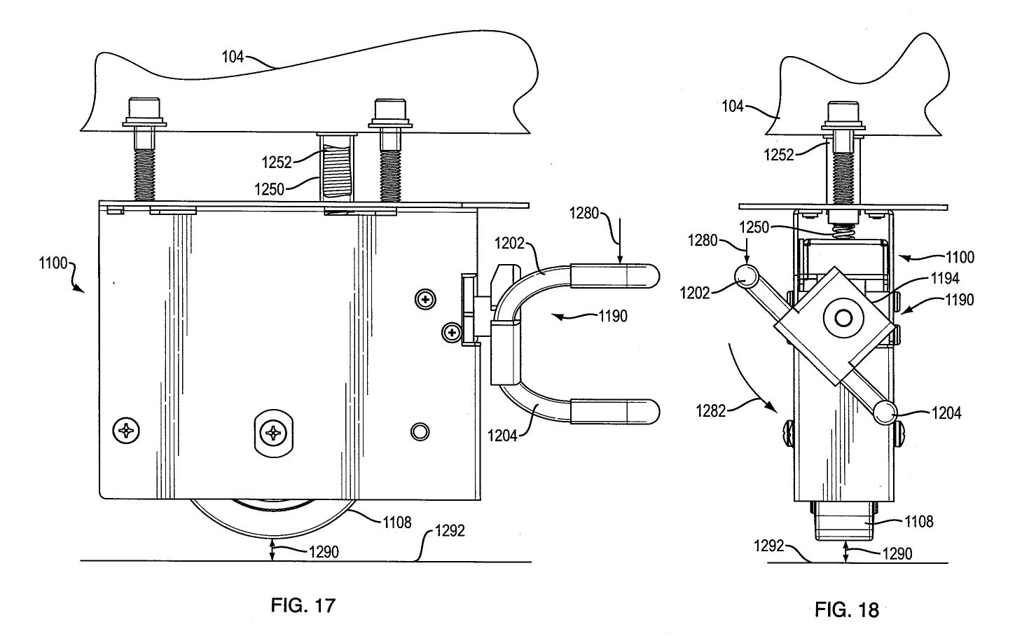

The actuator 1194 includes a base 1200 having a first actuator arm 1202 and a second actuator arm 1204 extending there from. In one arrangement, the first actuator arm 1202 is substantially parallel to the second actuator arm 1204 such that the first actuator arm 1202, the second actuator arm 1204, and the base 1200 define a substantially U-shaped structure, as best illustrated in FIG. 17.

The actuator 1194 is configured to support relatively large loads, such as up to about 220 pounds of substantially constant force, to activate the cam mechanism 1190. In one arrangement, with reference to both FIGS. 15 and 20, to provide such support, each of the actuator arms 1202, 1204 are disposed at a location that is off-axis relative to a center of rotation of the actuator 1194. For example, the actuator 1194 defines a center of rotation 1210. A longitudinal axis 1212 of the first actuator arm 1202 is disposed at a vertical offset distance 1216 from the center of rotation 1210 and at a first lateral distance 1218 from the center of rotation 1210 of the actuator 1194. Additionally, a longitudinal axis 1214 of the second actuator arm 1204 is disposed at the vertical offset distance 1216 from the center of rotation 1210 of the actuator 1194 and at a second lateral distance 1220 from the center of rotation 1210, the second lateral distance 1220 extending on the opposite direction from the first lateral distance 1218.

With such a configuration, when mounted to the base of a cart, the actuator 1194 and associated wheel positioning assembly 1104 can be operated by a user's foot. For example, as will be described in detail below, the user can depress the first actuator arm 1202 with his foot to move the wheel assembly 1102 from a retracted position (FIG. 18) to an extended position (FIG. 19) or can depress the second actuator arm 1204 with his foot to move the wheel assembly 1102 from an extended position (FIG. 19) to a retracted position (FIG. 18). With the actuator arms 1202, 1204 disposed at locations that are off-axis to the center of rotation 1210 of the actuator 1194, the actuator arms 1202, 1204 offset the moment arm associated with the cam mechanism 1190, thereby minimizing potential damage to the cam mechanism 1190 when exposed to relatively large loads, such as applied by the user's foot. Additionally, to minimize slipping of the user's foot from the first or second actuator arms 1202, 1204 during operation, the one or both of the actuator arms 1202, 1204 can include non-skid or slip resistant coverings 1206, 1208 such as rubber sleeves.

With reference to FIG. 15, to allow the actuator 1194 to rotate, the actuator 1194 includes a cam axle 1222 and support structure 1198. In one arrangement, the cam axle 1222 is integrally formed with, and extends longitudinally from, the cam element 1196 and is disposed substantially at the center of rotation 1210 of the actuator 1194. In one arrangement, the support structure 1198 is configured to support the cam axle 1222. For example, the support structure 1198 defines an opening 1224 configured to receive the cam axle 1222 and allow rotation of the calm axle 1222 and the cam element 196 relative to the support structure 1198. In one arrangement, the support structure 1198 includes a set of bushings 1226 and a fastener 1228 to secure the cam axle 1222 to the support structure 1198 while allowing for rotation of the cam axle 1222 relative to the support structure 1198 while minimizing noise associated with movement of the actuator 1194.

With additional reference to FIG. 16, the support structure 1190 is configured to be secured to the traction wheel assembly housing 1106. For example, with reference to FIG. 14, the traction wheel assembly housing 1106 and the wheel assembly 1102 define a chamber 1180 configured to carry the support structure 1190 of the wheel-positioning assembly 1104. In one arrangement, as indicated in FIG. 15, the support structure 1198 includes a base plate 1230 secured to the support structure 1198 with fasteners 1232. The base plate 1230 is configured to mount a front portion of the support structure 1198 in the traction wheel assembly housing 1106. For example, with continued reference to FIGS. 15 and 16, the base plate 1230 includes a first support 1234 configured to insert within a slot 1238 defined by the traction wheel assembly housing 1106 and includes a second support 1236 configured to be carried by a shelf 1240 defined by the traction wheel assembly housing 1106. The support structure 1198 further couples to the traction wheel assembly housing 1106 via fasteners 1242.

As indicated above, the actuator 1190 includes a cam element 1196. As will be described below, the cam element 1196 interacts with the spring mechanism 1192 to adjust the position of the wheel assembly 1102 relative to the traction wheel assembly housing 1106.

In one arrangement, with reference to FIGS. 16-18, the spring mechanism 1192 includes a spring element 1250 and a spring element housing 1252 disposed between the frame 104 and the cam mechanism 1190. While the spring element 1250 can be configured in a variety of ways, in one arrangement, the spring element 1250 is configured as a compression spring which is biased in an open or expanded state. As indicated in FIGS. 16-18, the spring element housing 1252 constrains the lateral movement of the spring element 1250 while the frame 104 and the cam element 1196 of the cam mechanism 1190 constrains the vertical movement of the spring element 1250. With such an arrangement, the cam element 1196 aligns with and contacts the spring element of the spring mechanism.

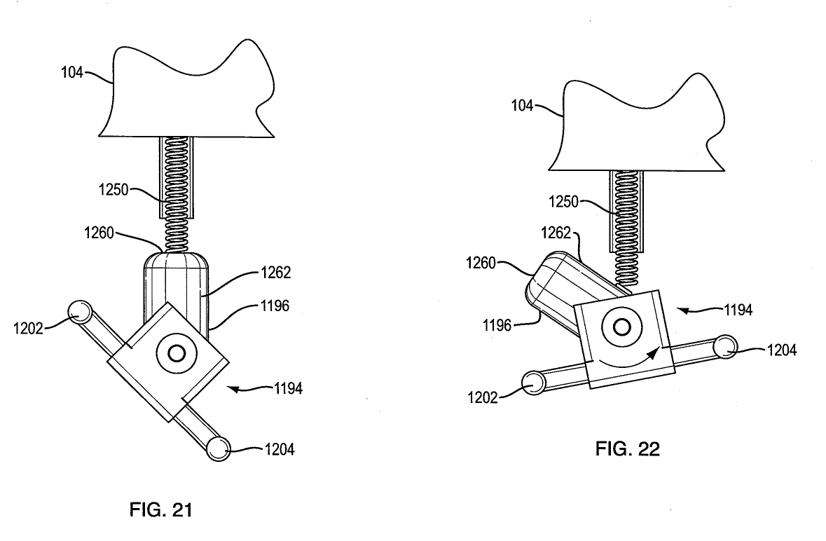

With reference to FIGS. 15 the cam element 1196 includes a spring lock portion 1260 and a spring support portion 1262. As shown in FIG. 21, the spring lock portion 1260 is configured to engage the spring element 1250 and maintain the spring element 1250 in a compressed state to position the wheel assembly 1102 in a retracted position relative to the frame 104. For example, the spring lock portion 1260 can be configured as a substantially flat surface which maintains compression of the spring element 1250 between the frame 104 and the cam element 1196.

As shown in FIG. 22, the spring support portion 1262 is configured to engage the spring element 1250 and maintain the spring element 1250 in an expanded state. For example, as the actuator 1194 moves the spring lock portion 1260 from the locked position shown in FIG. 21 to an unlocked position, the spring element 1250 expands to position the wheel assembly 1102 in an extended position relative to the frame 104. The spring support portion 1262 is configured to support the spring element 1250 and maintain a degree of compression on the spring element 1250. By maintaining the spring element 1250 with some level of compression, the spring support portion 1262 allows the spring element 1250 to operate as a shock absorber when the wheel assembly 1102 is disposed in an extended position to maintain contact between the wheel 1108 and an opposing surface such as a floor.

In use, the cam mechanism 1190 maintains the wheel assembly 1102 in one of a retracted position and an extended position relative to the frame 104. For example, as shown in FIGS. 17, 18, and 21, when the cam mechanism 1190 is disposed in a first position, the spring lock portion 1260 of the cam element 1196 maintains the spring element 1250 in a compressed and locked position. As indicated, with such positioning, the wheel 1108 of the wheel assembly 1102 is maintained at a distance 1290 from the opposing surface 1292, such as a floor. Additionally with such positioning, the first actuator arm 1202 is disposed in a retracted state relative to the frame 104 and the second actuator arm 1204 is disposed in an extended state relative to the frame 104.

As a user applies a substantially consistent load 1280 to the first actuator arm 1202, the actuator 1194 rotates along direction 1282, thereby causing the spring support portion 1262 to contact the spring element 1252 to allow the spring element 1252 to expand. As a result of the expansion of the spring element 1252, the spring element 1252 generates a load on the cam mechanism 1190 directed away from the frame 104. This load causes the wheel assembly 1102 to rotate about the pivot mounting assembly 1134 of the traction wheel assembly housing 1106 and allow the wheel 1108 to contact the opposing surface 1292, as shown in FIG. 19. Also as a result of expansion of the spring element 1252, as indicated in FIGS. 19 and 22, the spring element 1252 causes the first actuator arm 1202 to be disposed in a extended state relative to the frame 104 and the second actuator arm 1204 is disposed in a retracted state relative to the frame 104.

In the above referenced configuration, the first and second actuator arms 1202, 1204 are positioned relative to the cart so that they can be easily accessed by a user's foot. Accordingly, the user can easily position the wheel assembly 1102 toward or away from the opposing surface 1292 using his foot.

As indicated above, the wheel assembly 1102 is configured to pivotably mount to the traction wheel assembly housing 1106. Such indication is by way of example only. In one arrangement the wheel assembly is configured to translate substantially linearly relative to the frame.

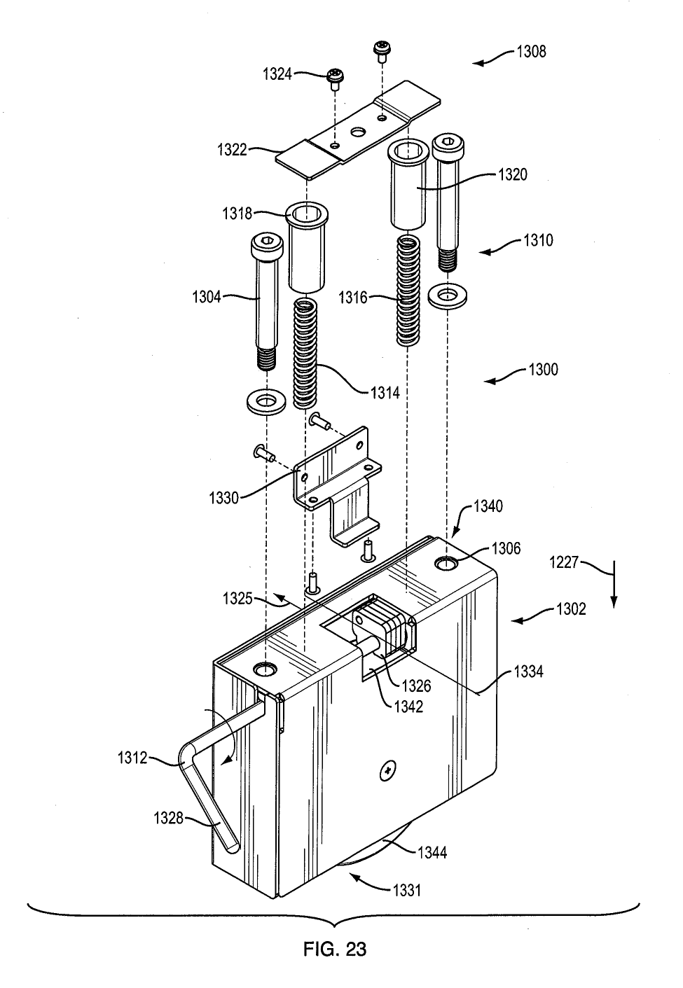

For example, FIG. 23 illustrates an arrangement of a traction wheel assembly 1300 that is configured to translatably couple to a frame. The traction wheel assembly 1300 includes a non-swiveling wheel assembly 1302 configured to mount to a frame (not shown) via fasteners 1304, such as carriage bolts. The fasteners 1304 insert within openings in the frame and secure to corresponding threaded openings 1306 defined by the wheel assembly 1302. The fasteners 1304, therefore, secure the wheel assembly 1302 to the frame and allow the wheel assembly 1302 to linearly translate relative to the frame.

The traction wheel assembly 1300 also includes a wheel-positioning assembly 1308 that includes a spring mechanism 1310 and a cam mechanism 1312. In one arrangement, the spring mechanism 1310 includes a first and second spring element 1314, 1316 and corresponding first and second spring element housings 1318, 1320 disposed between a cover portion 1322 and the wheel assembly 1302. While the first and second spring elements 1314, 1316 can be configured in a variety of ways, in one arrangement, the spring elements 1314, 1316 are configured as compression springs. The cover portion 1322 secures to the frame via fasteners 1324.

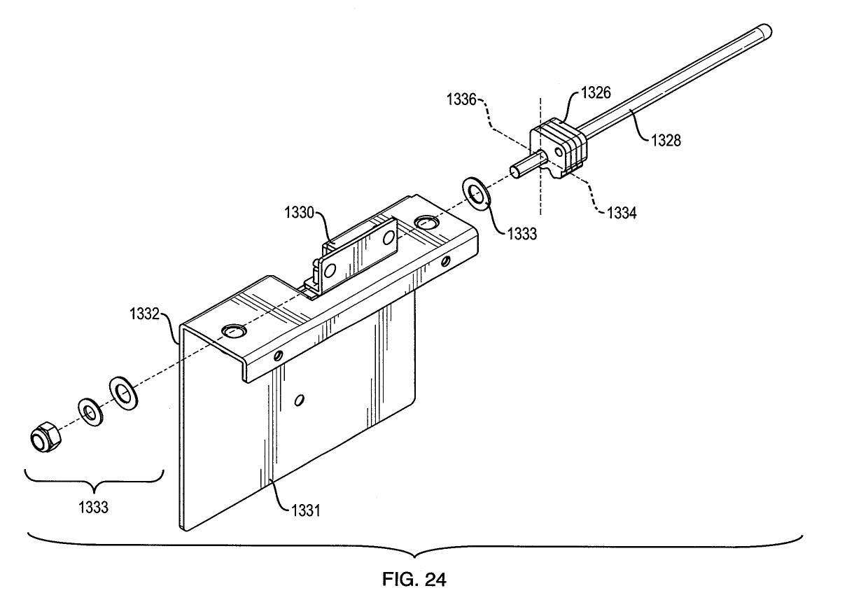

The cam mechanism 1312 is coupled to a housing 1331 via a fastener apparatus 1333 and includes a cam element 1326 and a corresponding cam lever 1328. A carrier 1330 supports the cam element 1326 within the housing 1331 of the wheel assembly 1308, as indicated in FIG. 24, while the housing 1331 supports the cam lever 1328, as indicated in FIG. 23.

With reference to FIG. 24, the cam element 1326 defines a longitudinal length along a longitudinal axis 1334 and a transverse length along a transverse axis 1336 where the longitudinal length is greater than the transverse length. The differences between the longitudinal and transverse lengths of the cam element 1326 allows the wheel-positioning assembly 1308 to dispose the wheel assembly 1300 in either a retracted or expanded position relative to the frame.

For example, with reference to FIG. 23, in the case where the longitudinal axis 1334 of the cam element 1326 is substantially perpendicular to a side housing wall 1332, the cam element 1326 generates a load between the housing wall 1332 and the frame along direction 1325 to lock the wheel assembly 1300 in a retracted position relative to the frame. As a user rotates the cam lever 1328, such as in a clockwise direction, the cam element 1326 rotates relative to the carrier 1330 such that the longitudinal axis 1334 is substantially perpendicular to a mounting portion 1340 of the housing 1331 and the cam element 1326 extends from an opening 1342 in the a mounting portion 1340. Such positioning relives the load between the cam element 1326 and the frame, thereby allowing the spring elements 1314, 1316 to expand and drive the housing 1331 and associated wheel 1344 substantially linearly along direction 1227 relative to the frame to an engaged position.

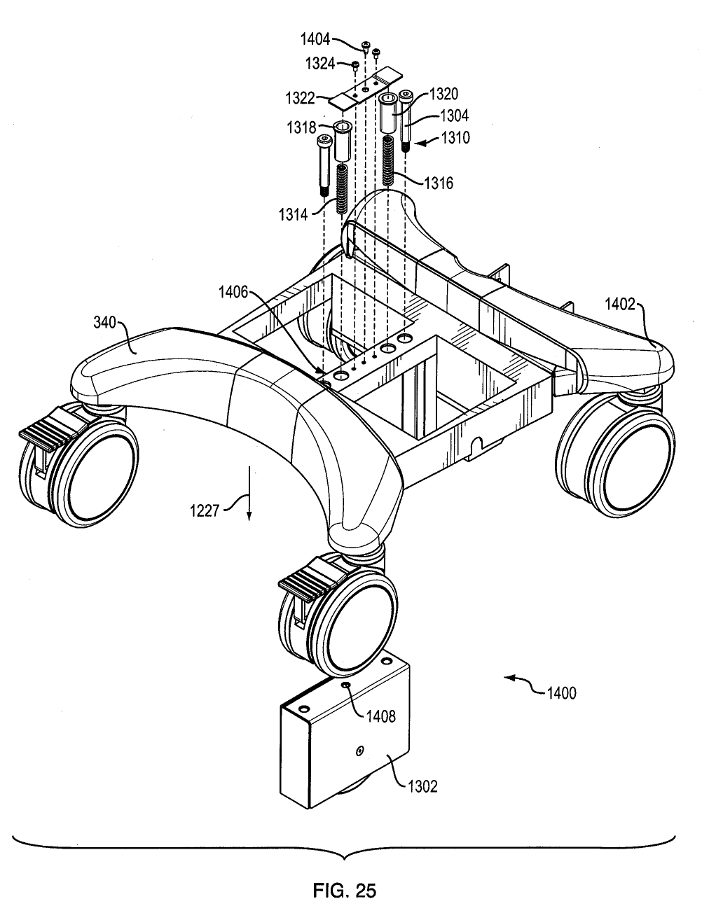

FIG. 25 illustrates another arrangement of a traction wheel assembly 1400 that is configured to translatably couple to a frame 1402. As illustrated, the fasteners 1304, such as carriage bolts, secure the wheel assembly 1400 to the frame 1402 such that the wheel assembly 1400 can linearly translate relative to the frame 1402. The wheel assembly 1400 further couples to the frame 1402 using a fastener 1404. The fastener 1404, such as a threaded bolt, mates with an opening 1406 defined by the frame 1402 (e.g., a threaded opening) and an opening 1408 (e.g., a threaded opening) defined by the wheel assembly 1400. Once assembled to the frame 1402, the user can utilize the fastener to manually activate the spring mechanism 1310 to position the wheel assembly 1400 between a retracted and an extended position. For example, a clockwise rotation of the fastener 1404 relative to the openings 1404, 1406 can draw the wheel assembly 1400 toward the frame 1402 in a retracted position while counter clockwise rotation of the fastener 1404 relative to the openings 1404, 1406 allows the spring elements 1314, 1316 to expand and drive the wheel assembly 1302 along direction 1227 substantially linearly relative to the frame 1402 to an expanded position.

While various embodiments of the invention have been particularly shown and described, it will be understood by those skilled in the art that various changes in form and details may be made therein without departing from the spirit and scope of the invention as defined by the appended claims.

What is claimed is:

1. A base for a cart, comprising:
a frame;
a set of swiveling wheel assemblies coupled to the frame, each swiveling wheel assembly of the set of swiveling wheel assemblies configured to swivel about a vertical axis associated with the frame; and
at least one traction wheel assembly coupled to the frame, the at least one traction wheel assembly having:
a non-swiveling wheel assembly configured to remain rotationally stationary relative to the vertical axis associated with the frame, and
a wheel-positioning assembly disposed in positional communication with the non-swiveling wheel assembly, the wheel-positioning assembly configured to position the non-swiveling wheel assembly between a retracted position relative to the frame and an extended position relative to the frame.

2. The base of claim 1, wherein the wheel-positioning assembly comprises a cam mechanism configured to maintain the non-swiveling wheel assembly in one of the retracted position and the extended position relative to the frame.

3. The base of claim 2, wherein the cam mechanism comprises an actuator having a first actuator arm and a second actuator arm, the first actuator arm being substantially parallel to the second actuator arm.

4. The base of claim 3, wherein the actuator arms define a substantially U-shaped structure.

5. The base of claim 3, wherein the actuator defines a center of rotation, the first actuator arm disposed at a vertical offset distance from the center of rotation and at a first lateral distance from the center of rotation and the second actuator arm disposed at the vertical offset distance from the center of rotation and at a second lateral distance from the center of rotation, the second lateral distance opposing the first lateral distance.

6. The base of claim 3, wherein the wheel-positioning assembly further comprises a spring element disposed between the frame and the cam mechanism, the cam mechanism comprising a cam element having:
a spring lock portion configured to engage the spring element and maintain the spring element in a compressed state to position the non-swiveling wheel assembly in the retracted position; and
a spring support portion configured to engage the spring element and maintain the spring element in an expanded state to position the non-swiveling wheel assembly in the extended position.

7. The base of claim 6, wherein:
the first actuator arm is disposed in a retracted state relative to the frame and the second actuator arm is disposed in an extended state relative to the frame when the cam mechanism maintains the spring element in the compressed state; and
the first actuator arm is disposed in a extended state relative to the frame and the second actuator arm is disposed in a retracted state relative to the frame when the cam mechanism maintains the spring element in the expanded state.

8. The base of claim 2, wherein:
the cam mechanism comprises a cam axle disposed at a center of rotation of the cam mechanism; and
the wheel positioning assembly further comprises a support structure configured to support the cam axle of the cam mechanism.

9. The base of claim 1, wherein the non-swiveling wheel assembly comprises a wheel coupled to a wheel housing by an axle, the wheel-positioning assembly configured to pivot the non-swiveling wheel assembly relative to the wheel housing and about the axle between the retracted position and the extended position.

10. The base of claim 1, wherein the wheel-positioning assembly is configured to linearly translate the non-swiveling wheel assembly relative to the frame between the retracted position and the extended position.

11. The base of claim 1, wherein the traction wheel assembly is disposed at substantially a center location of the frame.

12. A base for a mobile cart, comprising:
a frame;
a set of swiveling wheel assemblies coupled to the frame, each swiveling wheel assembly of the set of swiveling wheel assemblies configured to swivel about a vertical axis associated with the frame; and
at least one traction wheel assembly coupled to the frame at substantially a center location of the frame, the at least one traction wheel assembly having:
a non-swiveling wheel assembly configured to remain rotationally stationary relative to the vertical axis associated with the frame, and
a wheel-positioning assembly disposed in positional communication with the non-swiveling wheel assembly, the wheel-positioning assembly having a cam mechanism configured to maintain the non-swiveling wheel assembly in one of the retracted position and the extended position relative to the frame and a spring element disposed between the frame and the cam mechanism, the cam mechanism having:
a spring lock portion configured to engage the spring element and maintain the spring element in a compressed state to position the non-swiveling wheel assembly in the retracted position relative to the frame; and
a spring support portion configured to engage the spring element and maintain the spring element in an expanded state to position the non-swiveling wheel assembly in the extended position relative to the frame.

13. The base of claim 12, wherein the cam mechanism comprises an actuator having a first actuator arm and a second actuator arm, the first actuator arm being substantially parallel to the second actuator arm.

14. The base of claim 13, wherein the actuator arms define a substantially U-shaped structure.

15. The base of claim 13, wherein the actuator defines a center of rotation, the first actuator arm disposed at a vertical offset distance from the center of rotation and at a first lateral distance from the center of rotation and the second actuator arm disposed at the vertical offset distance from the center of rotation and at a second lateral distance from the center of rotation, the second lateral distance opposing the first lateral distance.

16. The base of claim 13, wherein:
the first actuator arm is disposed in a retracted state relative to the frame and the second actuator arm is disposed in an extended state relative to the frame when the cam mechanism maintains the spring element in the compressed state; and
the first actuator arm is disposed in a extended state relative to the frame and the second actuator arm is disposed in a retracted state relative to the frame when the cam mechanism maintains the spring element in the expanded state.

17. The base of claim 12, wherein:
the cam mechanism comprises a cam axle disposed at a center of rotation of the cam mechanism; and
the wheel positioning assembly further comprises a support structure configured to support the cam axle of the cam mechanism.

18. The base of claim 12, wherein the non-swiveling wheel assembly comprises a wheel coupled to a wheel housing by an axle, the non-swiveling wheel assembly configured to pivot relative to the wheel housing and about the axle between the retracted position and the extended position.

19. The base of claim 12, wherein the wheel-positioning assembly is configured to linearly translate the non-swiveling wheel assembly relative to the frame between the retracted position and the extended position.
